(19) United States
(12) Patent Application Publication
(10) Pub. No.: US 2013/0296008 A1
(43) Pub. Date: Nov. 7, 2013

(54) SYSTEMS AND METHODS FOR PLAYING CARDS WITH DIGITAL ENHANCEMENTS AND ELECTRONIC INK

(71) Applicant: Ty Hardison, Atlanta, GA (US)

(72) Inventor: Ty Hardison, Atlanta, GA (US)

(21) Appl. No.: 13/886,495

(22) Filed: May 3, 2013

Related U.S. Application Data
(60) Provisional application No. 61/642,240, filed on May 3, 2012.

(51) Int. Cl. A63F 13/00

(52) U.S. Cl. CPC A63F 13/005
USPC 463/11

(57) ABSTRACT

A playing card system, a deck of playing cards, and a method include playing cards with digital enhancements and electronic ink. Exemplary embodiments of this invention include a system and method to enable traditional playing cards to be embedded with computer chip technology. These new playing cards with embedded chips will then be able to communicate with each other and a central command center that will add an additional element to the gaming experience. The playing cards can include electronic paper or electronic ink that can change the face or the back of the card or display messages to players. In an exemplary embodiment, a handicapping system can be used to teach a player how to play various games or to play more advanced players with assistance. In another exemplary embodiment, the back of the card could change to display messages, advertisements, or the like

### CROSS-REFERENCE TO RELATED APPLICATIONS

The following non-provisional Utility Patent Application claims priority to U.S. Provisional Patent Application Ser. No. 61/642,240 filed May 3, 2012 and entitled “SYSTEMS AND METHODS FOR DIGITAL CHIP EMBEDDED PLAYING CARDS,” the content of which are incorporated by reference herein.

### FIELD OF THE INVENTION

Generally, the field of art of the present disclosure pertains to game systems and methods, and more particularly, to systems and methods for playing cards with digital enhancements and electronic ink.

### BACKGROUND OF THE INVENTION

Referring to FIG. 1, a playing card is a piece of specially prepared heavy paper, thin cardboard, plastic-coated paper, cotton-paper blend, or thin plastic, marked with distinguishing motifs and used as one of a set for playing card games. Playing cards are typically palm-sized for convenient handling. A complete set of cards is called a pack or deck, and the subset of cards held at one time by a player during a game is commonly called a hand. A deck of cards may be used for playing a great variety of card games, with varying elements of skill and chance, some of which are played for money. Because playing cards are standardized and commonly available, they are used for other purposes, such as illusions, cartomancy, cardistry, and building card structures. The front (or “face”) of each card carries markings that distinguish it from the other cards in the deck and determine its use under the rules of the game being played. The back of each card is identical for all cards in any particular deck, and usually of a single color or formalized design. Usually every card will be smooth; however, some decks have braille to allow blind people to read the card number and suit. The backs of playing cards are sometimes used for advertising. For most games, the cards are assembled into a deck, and their order is randomized by shuffling.

### BRIEF SUMMARY OF THE INVENTION

In an exemplary embodiment, a playing card system includes a plurality of playing cards each comprising an identification mechanism; modifiable display on each of the plurality of playing cards that is communicatively coupled to the identification mechanism; a controller communicatively coupled to each of the plurality of playing cards via the identification mechanisms; and an algorithm executed by the controller to track each of the plurality of playing cards in a game setting. The modifiable display on each of the plurality of playing cards can include electronic ink or paper. The playing card system can further include a power source in each of the plurality of playing cards coupled to each of the identification mechanism and the modifiable display. The power source can be configured to charge while a playing card is on a charging surface or in a box. The charging surface can include a playing table. The algorithm executed by the controller can be further configured to selectively modify the modifiable display on each of the plurality of playing cards. The algorithm executed by the controller can be further configured to selectively modify the modifiable display on a back of each card to display an advertisement or message thereon. The algorithm executed by the controller can be further configured to track the display of the advertisement or message to monitor player exposure thereto. The algorithm executed by the controller can be further configured to selectively modify the modifiable display on a front of each card to display training information for a selected game to teach a player. The algorithm executed by the controller can be further configured to selectively modify the modifiable display on a front of each card to display assistance for a selected game to enable a player with a defined handicap to player with other players with more skill. The algorithm executed by the controller can be further configured to track the player's progress to define the defined handicap. The defined handicap can be manually input into the algorithm.

In another exemplary embodiment, a deck of playing cards includes a plurality of cards each comprising a distinct visual identifier; circuitry disposed on each of the plurality of cards; a modifiable electronic display on each of the plurality of cards; a power supply disposed within or on each of the plurality of cards; an identification mechanism disposed on each of the plurality of cards, wherein the identification mechanism is configured to track and uniquely identity each of the plurality of cards at a controller; and an interface between the circuitry, the modifiable electronic display, the power supply, and the identification mechanism. The power source can be configured to charge while a playing card is on a charging surface or in a box. The charging surface can include a playing table. An algorithm executed by the controller can be configured to selectively modify the modifiable electronic display on a back of each card to display an advertisement or message thereon. The algorithm executed by the controller can be further configured to track the display of the advertisement or message to monitor player exposure thereto. An algorithm executed by the controller can be configured to selectively modify the modifiable electronic display on a front of each card to display training information for a selected game to teach a player. An algorithm executed by the controller can be configured to selectively modify the modifiable electronic display on a front of each card to display assistance for a selected game to enable a player with a defined handicap to player with other players with more skill; wherein the algorithm executed by the controller can be further configured to track the player's progress to define the defined handicap or the defined handicap is manually input into the algorithm.

In yet another exemplary embodiment, a method includes providing a plurality of playing cards each comprising a modifiable display thereon and circuitry coupled to the modifiable display; tracking each of the plurality of playing cards by a controller communicatively coupled to the circuitry via a wireless mechanism; monitoring game play of a selected game and one or more players by the controller; maintaining historical statistics of the game play for the one or more players; selectively modifying modifiable display on each of the plurality of playing cards to provide any of updated advertisements or messages, hints, suggestions, training, and game statistics.

### BRIEF DESCRIPTION OF THE DRAWING(S)

Exemplary and non-limiting embodiments of the present disclosure are illustrated and described herein with reference to various drawings, in which like reference numbers denote like method steps and/or system components, respectively, and in which:

FIG. 1 is a schematic diagram of playing cards;

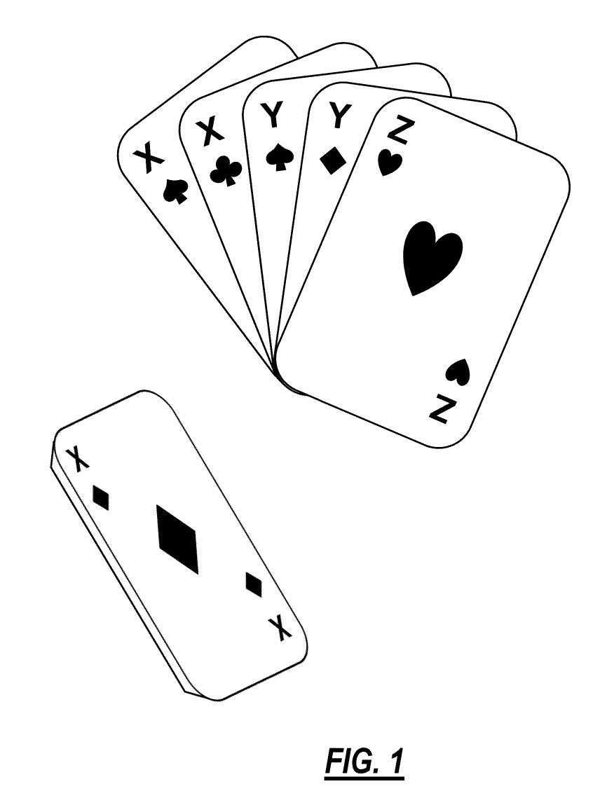

FIG. 2 is a schematic diagram of an exemplary implementation of a playing card system;

FIG. 3 is a block diagram of an exemplary implementation of a computing device;

FIG. 4 is a flowchart of a training method utilizing the playing card system of FIG. 1; and

FIG. 5 is a flowchart of a handicapping method utilizing the playing card system of FIG. 1.

### DETAILED DESCRIPTION OF THE INVENTION

In various exemplary embodiments, systems and methods for playing cards with digital enhancements and electronic ink are described. Exemplary embodiments of this invention include a system and method to enable traditional playing cards to be embedded with computer chip technology. These new playing cards with embedded chips will then be able to communicate with each other and a central command center that will add an additional element to the gaming experience. The playing cards can include electronic paper or electronic ink that can change the face or the back of the card or display messages to players. In an exemplary embodiment, a handicapping system can be used to teach a player how to play various games or to play more advanced players with assistance. In another exemplary embodiment, the back of the card could change to display messages, advertisements, or the like.

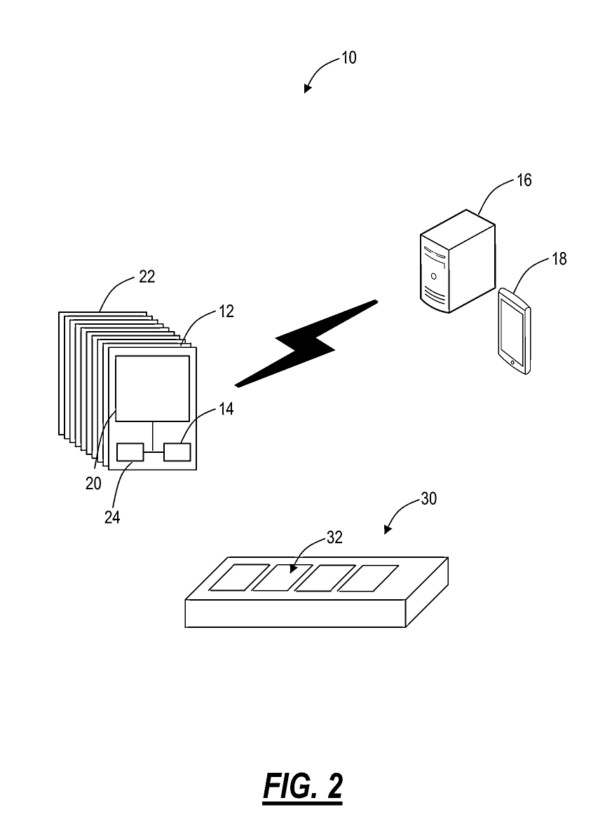

Referring to FIG. 2, in an exemplary embodiment, a playing card system 10 is illustrated. The playing card system 10 includes playing cards 12 with an identification mechanism 14 that can be communicatively coupled to a server 16 and/or a mobile device 18. The playing cards 12 can further include a display area 20 on a front of each card 12, a display area 22 on a back of each card 12, and a power mechanism 24 that can be coupled to the identification mechanism 14 and the display areas 20, 22. The server 16 and/or the mobile device 18 can include a central command center host to control the use of NFC (near field communication) or other transponder technology (RFID, Bluetooth, etc.) to communicate with individual cards 12. As such, the deck of playing cards 12 can function as a group of cards allowing for such activities as keeping score, teaching aid, alerting a winning hand or error in play, using an algorithm to determine an acceptable shuffle, handicapping, or the like.

The identification mechanism 14 can include NFC, RFID, Bluetooth, etc. For example, the identification mechanism 14 can include digital chips embedded in the playing cards 12 that could be connected to other electronics such as fibers that would effectively light up or flash drawing attention to a card or a group of cards. The identification mechanism 14 can be a two-way communication mechanism that allows the server 16 and/or the mobile device 18 to know the identity of each card 12 and proximate cards 12 in a user's hand as well as to program the display areas 20, 22.

In an exemplary embodiment, a base command center could be a box 30 that these new playing cards 12 come packaged in with a touch screen 32 to select game play or set options during play. For example, the box 30 can include the touch screen 32 as well as a power source such as a battery and a communication mechanism to connect to the identification mechanism 14. For example, the box 30 can determine if a shuffle was proper based on a first command to the touch screen 32 which identifies a current state of the playing cards 12 followed by one or more shuffles followed by a second command to the touch screen 32 which identifies a difference between a present state of the playing cards 12 compared to the pre-shuffle state of the playing cards 12.

In another exemplary embodiment, the playing card system 10 can include a smart phone, tablet or similar device equipped with NFC or similar technology to communicate with the cards 12 via the identification mechanism 14, the device 16, 18 and app could be used as the command center effectively governing the game play. Similar to the box 30, the device 16, 18 and app could determine an appropriate shuffle or not based on the commands. Additionally, the device 16, 18 and app can communicate over a network such as the Internet to receive various updates such as new displays for the display areas 20, 22.

In the foregoing exemplary embodiments, those of ordinary skill in the art will recognize the playing card system 10 can use the playing cards 12 with either the device 16, 18 and app or the box 30 for similar functionality. The device 16, 18 and app or the box 30 can be referred to as having a command center communication capability to the cards 12 and to a network such as the Internet. Further using the command center's communication capability to update the version of the system 10, upgrade chip specs such as on the card 12, the app, the box 30, etc., program new card designs via the display areas 20, 22, etc., it is further able to build a community of users who could play in virtual tournaments, invent new games or “house rules” provide remote expert help and training, create new card designs, and more. This new delivery system and method may include parental controls (age and content limits) as well as tracking when, where and how long a contest has been ongoing (lifetime achievement) and post to social networking services like Facebook, Google and Twitter.

With the display areas 20, 22, the identification mechanism 14 could control the playing cards 12 made from e-ink or digital paper to control dynamically the playing cards 12 appearance, for example making the font larger or changing the style of game, etc. The customizable playing cards 12 can use new and existing e-ink and e-paper technologies communicating from playing card 12 to the command center communication capability through the use of NFC (near field communication) or other transponder technology (RFID, Bluetooth) so that the playing card can change and take on an unlimited number of different designs. Additional features can include:

Ability to support any language or character set including the ability for the electronic playing card 12 application to translate into other languages.

A new digital playing card system 10 that provides a platform where users can register, match and manage any new advertising model that might be displayed on the backs of the playing card. The system and method can support various advertising company's use of this new screen media. This can be accomplished through electronic ink or paper.

The digital playing card system 10 can support multiple materials from a variety of papers, vinyls to water-resistant plastics and other mediums.

Hints can be provided in a handicapping mode where a player is new or has less skill than his opponents. Additionally, the cards 12 can be in a teaching mode to teach a player strategy and how to play a specific game.

Variously, the systems and methods combine technologies such as NFC and the ability to effectively embed chips into printed materials, in this case a deck of playing cards 12, to create systems and methods for an electronic playing card platform that can include mobile applications connecting the Near Field Communication (NFC) specifications of the device with playing cards 12 made of traditional materials or of advancements in electronic paper and e-ink technology.

Near field communication (NFC) is a set of standards for smart phones and similar devices to establish radio communication with each other by touching them together or bringing them into close proximity. The systems and methods use of this technology can include applications that use its ability of data exchange, and communication between an NFC device and an unpowered NFC chip or tag. NFC standards cover communications protocols and data exchange formats, and are based on existing radio-frequency identification (RFID) standards. NFC was approved as an ISO/IEC standard on Dec. 8, 2003 and later as an ECMA standard. NFC is an open platform technology standardized in ECMA-340 and ISO/IEC 18092. These standards specify the modulation schemes, coding, transfer speeds and frame format of the RF interface of NFC devices, as well as initialization schemes and conditions required for data collision-control during initialization for both passive and active NFC modes. Furthermore, they also define the transport protocol, including protocol activation and data-exchange methods. In addition, the NFC Forum has defined a common data format called NFC Data Exchange Format (NDEF), which can store and transport various kinds of items.

Many new NFC-enabled handsets are on the market or are planned. Currently NFC devices are being tested as payment systems and identity documents. There are currently several published APIs including one for the Google Android system to allow smart phone applications to be developed that will take advantage of the phones NFC capabilities. NFC and Bluetooth are both short-range communication technologies which are integrated into mobile phones. An exemplary use case can take advantage of the growing deployment of NFC in smartphone and tablet devices because unlike Bluetooth, NFC does not require pairing and consumes far less power.

Electronic paper, e-paper and electronic ink are a range of display technology which are designed to mimic the appearance of ordinary ink on paper. Unlike conventional backlit flat panel displays which emit light, electronic paper displays reflect light like ordinary paper. Many of the technologies can hold static text and images indefinitely without using electricity, while allowing images to be changed later. Several companies are simultaneously developing electronic paper and ink. While the technologies used by each company provide many of the same features, each has its own distinct technological advantages. There are many technologies being applied to electronic paper include modifications of liquid crystal displays, electrochromic displays. Advantages of electronic paper includes low power usage (power is only drawn when the display is updated), flexibility and better readability than most displays. Electronic ink can be printed on any surface.

The power mechanism 24 can include a battery or some other mechanism for holding a small amount of electrical power to operate the identification mechanism 14 and the display areas 20, 22. In an exemplary embodiment, the power mechanism 24 can charge when the playing cards 12 are laid on a table or in the box 30 utilizing wireless charging technologies via induction technology. For example, the power can be transferred electrically through magnetic fields. Of note, the identification mechanism 14 and the display areas 20, 22 require low amounts of power thereby enabling the power mechanism 24 to be small and fit on each of the playing cards 12.

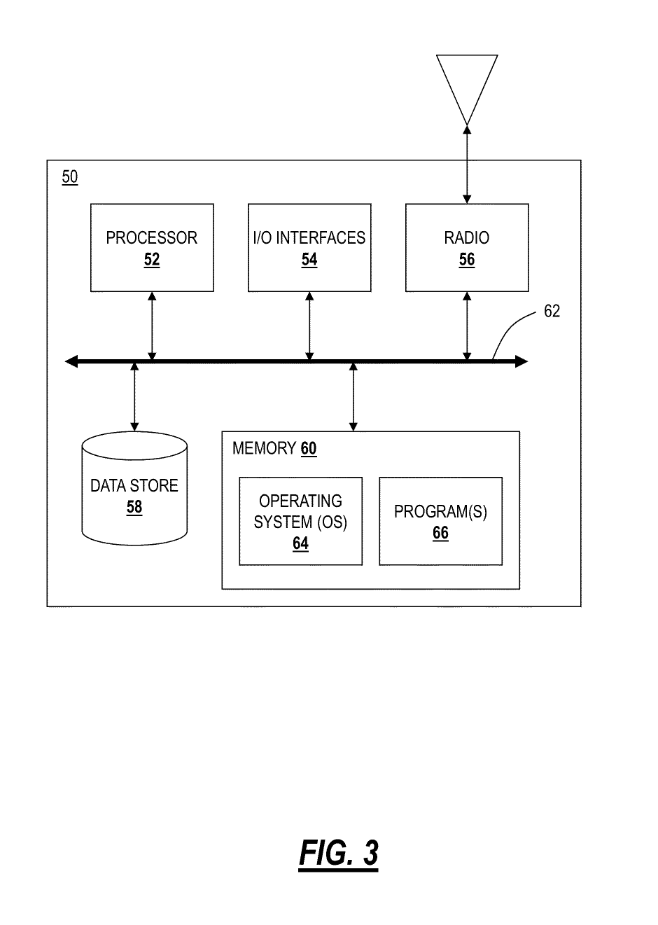

Referring to FIG. 3, in an exemplary embodiment, a block diagram of an exemplary implementation of a computing device 50. Of note, the computing device 50 can be the device 16, 18 and app or the box 30. The computing device 50 can be a digital device that, in terms of hardware architecture, generally includes a processor 52, input/output (I/O) interfaces 54, a radio 56, a data store 58, and memory 60. It should be appreciated by those of ordinary skill in the art that FIG. 3 depicts the computing device 50 in an oversimplified manner, and a practical embodiment can include additional components and suitably configured processing logic to support known or conventional operating features that are not described in detail herein. The components (52, 54, 56, 58, and 60) are communicatively coupled via a local interface 62. The local interface 62 can be, for example but not limited to, one or more buses or other wired or wireless connections, as is known in the art. The local interface 62 can have additional elements, which are omitted for simplicity, such as controllers, buffers (caches), drivers, repeaters, and receivers, among many others, to enable communications. Further, the local interface 62 may include address, control, and/or data connections to enable appropriate communications among the aforementioned components.

The processor 52 is a hardware device for executing software instructions. The processor 52 can be any custom made or commercially available processor, a central processing unit (CPU), an auxiliary processor among several processors associated with the computing device 50, a semiconductor-based microprocessor (in the form of a microchip or chip set), or generally any device for executing software instructions. When the computing device 50 is in operation, the processor 52 is configured to execute software stored within the memory 60, to communicate data to and from the memory 60, and to generally control operations of the computing device 50 pursuant to the software instructions. In an exemplary embodiment, the processor 52 may include a mobile optimized processor such as optimized for power consumption and mobile applications. The I/O interfaces 54 can be used to receive user input from and/or for providing system output. User input can be provided via, for example, a keypad, a touch screen, a scroll ball, a scroll bar, buttons, bar code scanner, and the like. System output can be provided via a display device such as a liquid crystal display (LCD), touch screen, and the like. The I/O interfaces 54 can also include, for example, a serial port, a parallel port, a small computer system interface (SCSI), an infrared (IR) interface, a radio frequency (RF) interface, a universal serial bus (USB) interface, and the like. The I/O interfaces 54 can include a graphical user interface (GUI) that enables a user to interact with the computing device 50.

The radio 56 enables wireless communication to an external access device or network. Any number of suitable wireless data communication protocols, techniques, or methodologies can be supported by the radio 56, including, without limitation: RF; LMR; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; LTE; cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 58 can be used to store data. The data store 58 can include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 58 can incorporate electronic, magnetic, optical, and/or other types of storage media.

The memory 60 can include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 60 may incorporate electronic, magnetic, optical, and/or other types of storage media. Note that the memory 60 can have a distributed architecture, where various components are situated remotely from one another, but can be accessed by the processor 52. The software in memory 60 can include one or more software programs, each of which includes an ordered listing of executable instructions for implementing logical functions. In the example of FIG. 3, the software in the memory 60 includes a suitable operating system (O/S) 64 and programs 66. The operating system 64 essentially controls the execution of other computer programs, and provides scheduling, input-output control, file and data management, memory management, and communication control and related services. The programs 66 can include various applications, add-ons, etc. configured to provide end user functionality with the computing device 50.

Further, exemplary embodiments include or incorporate at least one database which may store software, descriptive data, system data, digital images and any other data item required by the other components necessary to effectuate any embodiment of the present system and method known to one having ordinary skill in the art. The databases may be provided, for example, as a database management system (DBMS), a relational database management system (e.g., DB2, ACCESS, etc.), and an object-oriented database management system (ODBMS), a file system or another conventional database packages as a few non-limiting examples. The databases can be accessed via a Structure Query Language (SQL) or other tools known to one having skill in the art.

With the programs 66, an exemplary embodiment includes an electronic service which utilizes the embedded chip 14 in the printed playing cards 12 with a system and method for users to manage game play. The electronic service can also design and functions using a mobile device and a digital chip embedded deck of playing cards 12 equipped with NFC or similar technology to fully manage their use, image display, features and revenue, from a central platform. This system and method may be enabled through “App Store” delivery model, enabling Internet or mobile users to enable dynamically on their PC, phone or mobile device in real time or on the fly, as they wish.

In its simplest form, an image processing system and method enables users to register their chip embedded playing cards 12, make it public, control privacy settings and set timing intervals and the ability to send to the registered playing card decks a defined set of images/graphics for display in certain areas, time frames, while in play or not and the like under previously agreed to limits or conditions. Users can view on their computer, iPad, smart phone and enabled with the playing card application.

Additional services, offers, options or other flexible business model rules may be included in a model such as offering discounts for frequent or continuous usage, or rewards if the user hits defined usage or display levels consistently or if they achieve targeted quality levels.

A key advantage of a digital chip embedded deck of playing card system 10 and method is the operational simplicity and flexibility it provides to the content providers willing to host social game play while also providing the user with more control over their overall operations.

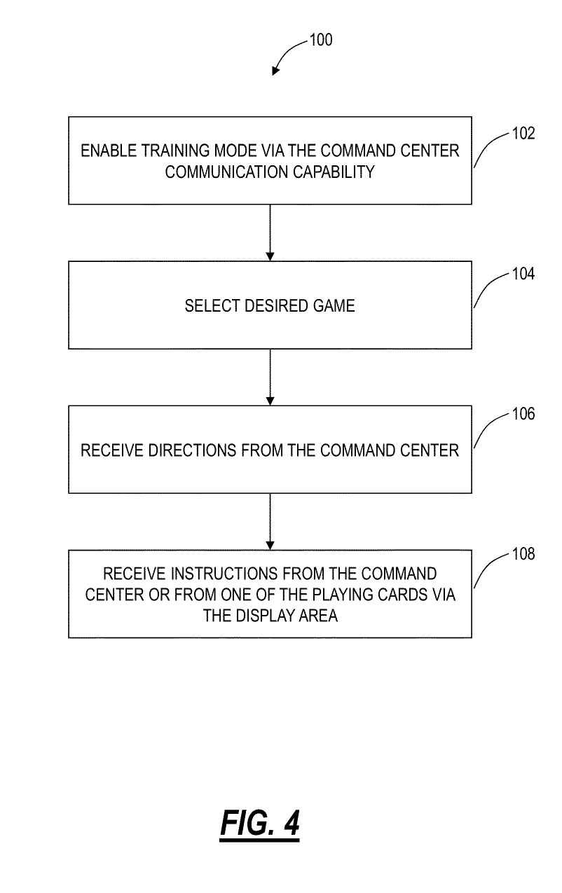

Referring to FIG. 4, in an exemplary embodiment, a flowchart illustrates a training method 100 utilizing the playing card system 10. The training method 100 can utilize the playing cards 12 and the command center (i.e., the box 30 or the device 16, 18 with an app). First, a training mode is enabled via the command center communication capability (step 102). This can include making various selections on the devices 16, 18 or on the box 30 via the touch screen 32. Next, a desired game is selected (step 104). In an exemplary embodiment, the command center can be preprogrammed with a plurality of different games including individual or multi-player games. In another exemplary embodiment, a user can download new games through the command center. In yet another exemplary embodiment, the command center can continuously download new games, updates, strategies, etc.

Next, a player receives directions from the command center (step 106). This can include initial steps such as how to shuffle the cards 12, how to deal the cards 12, etc. Step 106 relates to the initial steps associated with the desired game. Finally, the player receives instructions from the command center or from one of the playing cards 12 via the display area 20, 22 (step 108). Here, in step 108, the system 10 instructs the player on each step regarding what to do next, strategy, game play, etc.

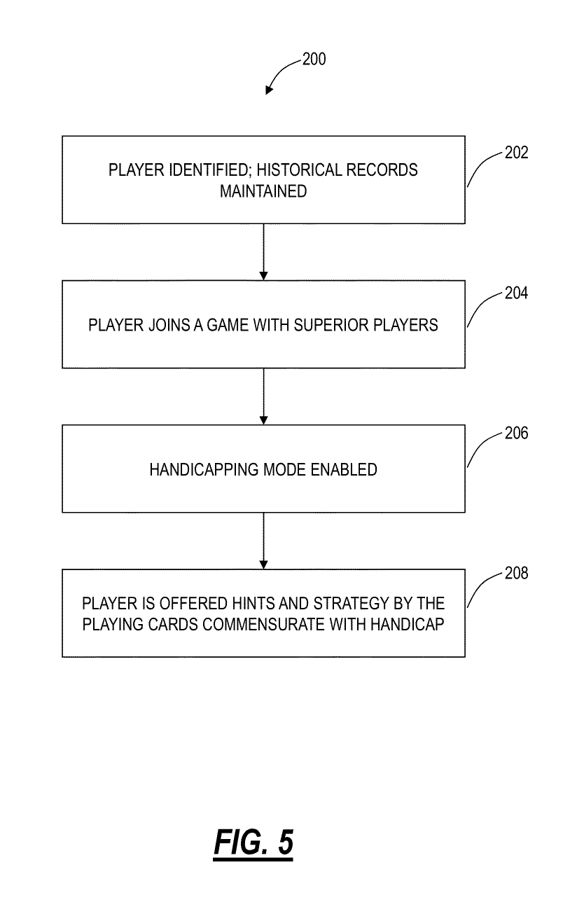

Referring to FIG. 5, in an exemplary embodiment, a flowchart illustrates a handicapping method 200 utilizing the playing card system 10. The handicapping method 200 is used with the playing card system 10 to enable lower skilled players to participate in games with higher skilled players. The handicapping method 200 includes identifying a player and maintaining historical records of that player's games to develop a handicap (step 202). For example, the playing card system 10 can also include a Web portal where the player registers as well as plays online games with other players or a computer to determine the player's handicap. The handicap can be some numerical representation of the player's skill at a particular game, e.g. poker. For example, the handicap can be developed based on how well a player performs each hand, whether the player makes good or bad decisions based on a particular hand as well as the hands of other players, and the like.

The handicapping method 200 includes the player joining a game with superior players (step 204). Here, the superior players could also have a defined handicap. Alternatively, the superior players may not have a handicap, and the playing card system 10 can be provided with a manual handicap. For example, the manual handicap can be one of a plurality of categories such as beginner, novice, intermediate, experienced, expert, pro, etc. Or the manual handicap can be a numerical range, e.g. 1 to 10, 1 to 100, etc.

The handicapping method 200 include enabling the handicapping mode with the playing card system 10 (step 206). The handicapping method 200 includes offering the player hints and strategy via the playing cards 12 commensurate with the player's handicap (step 208). Here, the identification mechanism 14 and the display areas 20, 22 can be used to provide in-game hints and strategy to players with lower skill level at a particular game. This allows novices and beginners to enjoy game play with more experienced players. The hints can include bet suggestions, which cards to play, etc.

Advantageously, the training method 100 and the handicapping method 200 leverage the electronic paper, e-ink that can change the face of the card along with the communication link to each card. When holding a deck of cards, i.e. holding the cards in the hand, each card knows the other card, rules, and can rely on an expertise that is built into the game to train, handicap, etc. Additionally, the changing card face can be used in a casino or the like to continuously provide new advertisements as well as tracking how often players are exposed to a brand. For older players, the changing card face can be used to enhance or make fonts larger. Further, the changing card face can enable easy new rules or house rules. There are endless number of options with an always changing card face.

The systems and methods described herein provide:

A platform to provide a teaching & scoring aid and card handicap system. For example, Bridge is a complex game that can be difficult to learn and uneven skill levels make it less enjoyable to participate in if partners and/or teams are unmatched. With the systems and methods, an in-play teaching aid can be provided to new players as well as a expert guide to assist as a sort of handicapping system. In addition, learning to keep score and recording score and shuffling are all aspects that could be handled instantly to make play faster and more enjoyable. These features could apply to all types of card games, from the classics to new card games yet to be invented.

A platform to publish new games/rules, a system to upload and download card games as well as the details of the characteristics of the card itself. Inventing a new game/rules and distributing them for play/sale could be thought of in a way similar to how the Kindle ereader has changed publishing and reading books. This service could provide ability to edit the card's design on the back or face of the card itself or the ability to make the font larger for easier visibility or based on the age of the players.

A platform to monitor game play for advertiser's brand exposure. Custom cards are ‘printed’ with different card backs and faces today. Each card can deliver a different communication point, visual, or fact representing an overall brand or message. Being able to create, control, disseminate, change, and monitor card designs to a community of cardholders instantly and electronically delivers a new advertising model with unique characteristics.

It will be appreciated that some exemplary embodiments described herein may include one or more generic or specialized processors (“one or more processors”) such as microprocessors, digital signal processors, customized processors, and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the aforementioned approaches may be used. Moreover, some exemplary embodiments may be implemented as a non-transitory computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer readable medium, software can include instructions executable by a processor that, in response to such execution, cause a processor or any other circuitry to perform a set of operations, steps, methods, processes, algorithms, etc.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure and are intended to be covered by the following claims.

What is claimed is:

1. A playing card system, comprising:
a plurality of playing cards each comprising an identification mechanism;
modifiable display on each of the plurality of playing cards that is communicatively coupled to the identification mechanism;
a controller communicatively coupled to each of the plurality of playing cards via the identification mechanisms; and
an algorithm executed by the controller to track each of the plurality of playing cards in a game setting.

2. The playing card system of claim 1, wherein the modifiable display on each of the plurality of playing cards comprises electronic ink or paper.

3. The playing card system of claim 1, further comprising:
a power source in each of the plurality of playing cards coupled to each of the identification mechanism and the modifiable display.

4. The playing card system of claim 3, wherein the power source is configured to charge while a playing card is on a charging surface or in a box.

5. The playing card system of claim 4, wherein the charging surface comprises a playing table.

6. The playing card system of claim 1, wherein the algorithm executed by the controller is further configured to selectively modify the modifiable display on each of the plurality of playing cards.

7. The playing card system of claim 1, wherein the algorithm executed by the controller is further configured to selectively modify the modifiable display on a back of each card to display an advertisement or message thereon.

8. The playing card system of claim 7, wherein the algorithm executed by the controller is further configured to track the display of the advertisement or message to monitor player exposure thereto.

9. The playing card system of claim 1, wherein the algorithm executed by the controller is further configured to selectively modify the modifiable display on a front of each card to display training information for a selected game to teach a player.

10. The playing card system of claim 1, wherein the algorithm executed by the controller is further configured to selectively modify the modifiable display on a front of each card to display assistance for a selected game to enable a player with a defined handicap to player with other players with more skill.

11. The playing card system of claim 10, wherein the algorithm executed by the controller is further configured to track the player's progress to define the defined handicap.

12. The playing card system of claim 10, wherein the defined handicap is manually input into the algorithm.

13. A deck of playing cards, comprising:
a plurality of cards each comprising a distinct visual identifier;
circuitry disposed on each of the plurality of cards;
a modifiable electronic display on each of the plurality of cards;
a power supply disposed within or on each of the plurality of cards;
an identification mechanism disposed on each of the plurality of cards, wherein the identification mechanism is configured to track and uniquely identity each of the plurality of cards at a controller; and
an interface between the circuitry, the modifiable electronic display, the power supply, and the identification mechanism.

14. The deck of playing cards of claim 13, wherein the power source is configured to charge while a playing card is on a charging surface or in a box.

15. The deck of playing cards of claim 14, wherein the charging surface comprises a playing table.

16. The deck of playing cards of claim 13, wherein an algorithm executed by the controller is configured to selectively modify the modifiable electronic display on a back of each card to display an advertisement or message thereon.

17. The deck of playing cards of claim 16, wherein the algorithm executed by the controller is further configured to track the display of the advertisement or message to monitor player exposure thereto.

18. The deck of playing cards of claim 13, wherein an algorithm executed by the controller is configured to selectively modify the modifiable electronic display on a front of each card to display training information for a selected game to teach a player.

19. The deck of playing cards of claim 13, wherein an algorithm executed by the controller is configured to selectively modify the modifiable electronic display on a front of each card to display assistance for a selected game to enable a player with a defined handicap to player with other players with more skill;
wherein the algorithm executed by the controller is further configured to track the player's progress to define the defined handicap or the defined handicap is manually input into the algorithm.

20. A method comprising:
providing a plurality of playing cards each comprising a modifiable display thereon and circuitry coupled to the modifiable display;
tracking each of the plurality of playing cards by a controller communicatively coupled to the circuitry via a wireless mechanism;
monitoring game play of a selected game and one or more players by the controller;
maintaining historical statistics of the game play for the one or more players;
selectively modifying modifiable display on each of the plurality of playing cards to provide any of updated advertisements or messages, hints, suggestions, training, game statistics, and quality of a shuffle.
